(19) United States
(12) Patent Application Publication
(10) Pub. No.: US 2014/0365571 A1
(43) Pub. Date: Dec. 11, 2014

(54) Automatically Determining Veracity of Documents Posted in a Public Forum

(71) Applicant: International Business Machines Corporation, Armonk, NY (US)

(72) Inventors: Kanak B. Agarwal, Austin, TX (US); Harm P. Hofstee, Austin, TX (US); Ruthie D. Lyle, Durham, NC (US); John K. Senegal, Durham, NC (US)

(21) Appl. No.: 13/915,098

(22) Filed: Jun. 11, 2013

(51) Int. Cl. H04L 29/06

(52) U.S. Cl. CPC H04L 29/06
USPC 709/204

(57) ABSTRACT

An approach is provided to determine the veracity of an online posting. In the approach, when a posting is received at a web site, a topic for the posting is automatically identified. The approach further identifies actions and corresponding action originators that have been taken to the posting, with the actions being events such as commenting, liking, disliking, re-sharing, posting the online posting. Veracity information is collected about the action originators. A veracity weighting for the action originators is assigned based on the collected veracity information. The actions are analyzed using the veracity weighting to form a weighted veracity summary which is provided to a viewer of the online posting

### TECHNICAL FIELD

The present disclosure relates to an approach that uses various sources to determine veracity of documents posted to a public repository, such as a forum.

### BACKGROUND OF THE INVENTION

For items posted on the Internet or other forms of public forum, it is often difficult to determine the items' veracity. One proposed method for evaluating veracity is performed at some sites where users are asked to rate the veracity of postings. In addition, in some sites the reviewers themselves are also rated because their ratings become “ratable documents”. The method currently used allows the website to assign weights, called “veracity metrics,” to the people who rate documents. However, what is lacking in the current approach is a method of determining veracity without requiring users to explicitly rate the veracity of documents or for users to rate the ratings of each other in order to determine reviewers' trustworthiness. In addition, many current systems are established in restricted settings that are available only to members who sign in to perform ratings, thus depriving many non-members of the content and knowledge contained in the posted items.

### SUMMARY

An approach is provided to determine the veracity of an online posting. In the approach, when a posting is received at a web site, a topic for the posting is automatically identified. The approach further identifies actions and corresponding action originators that have been taken to the posting, with the actions being events such as commenting, liking, disliking, re-sharing, reposting the online posting. In addition, the approach further identifies the number of people that have completed an action in response to the posting. Veracity information is collected about the action originators. This information can be obtained by inspecting public information such as social media sources, public articles, etc. A veracity weighting for the action originators is assigned based on the collected veracity information. The actions are analyzed using the veracity weighting to form a weighted veracity summary which is provided to a viewer of the online posting.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a component diagram showing the various components used in performing automatically determining the veracity of documents posted to an online forum;

FIG. 4 is a depiction of a flowchart showing the logic used in a forum document quality control process that generates veracity data based on document actions; and

FIG. 5 is a depiction of a flowchart showing the logic used in a document veracity engine to gather document related veracity information used to generate veracity scores pertaining to documents.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer, server, or cluster of servers. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

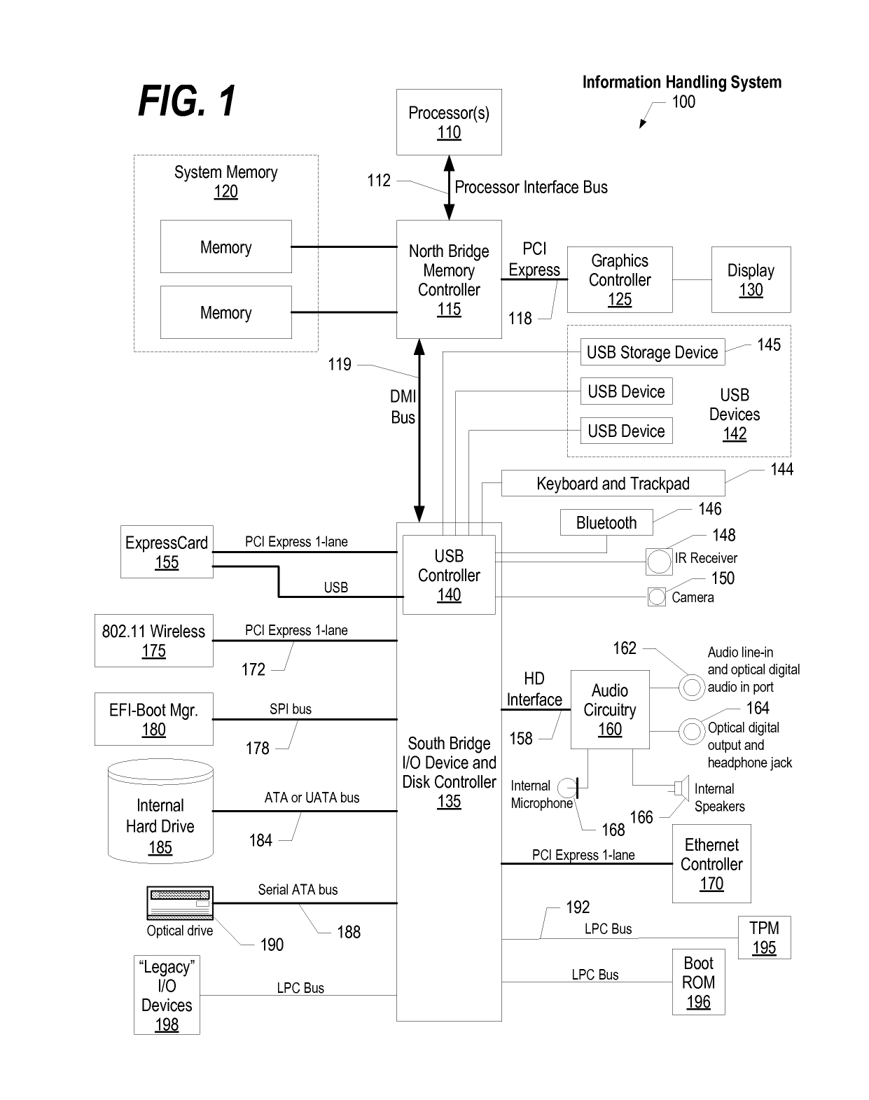

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etceteras.

Wireless Local Area Network (LAN) device 175 connects to Southbridge 135 via the PCI or PCI Express bus 172. LAN device 175 typically implements one of the IEEE 0.802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

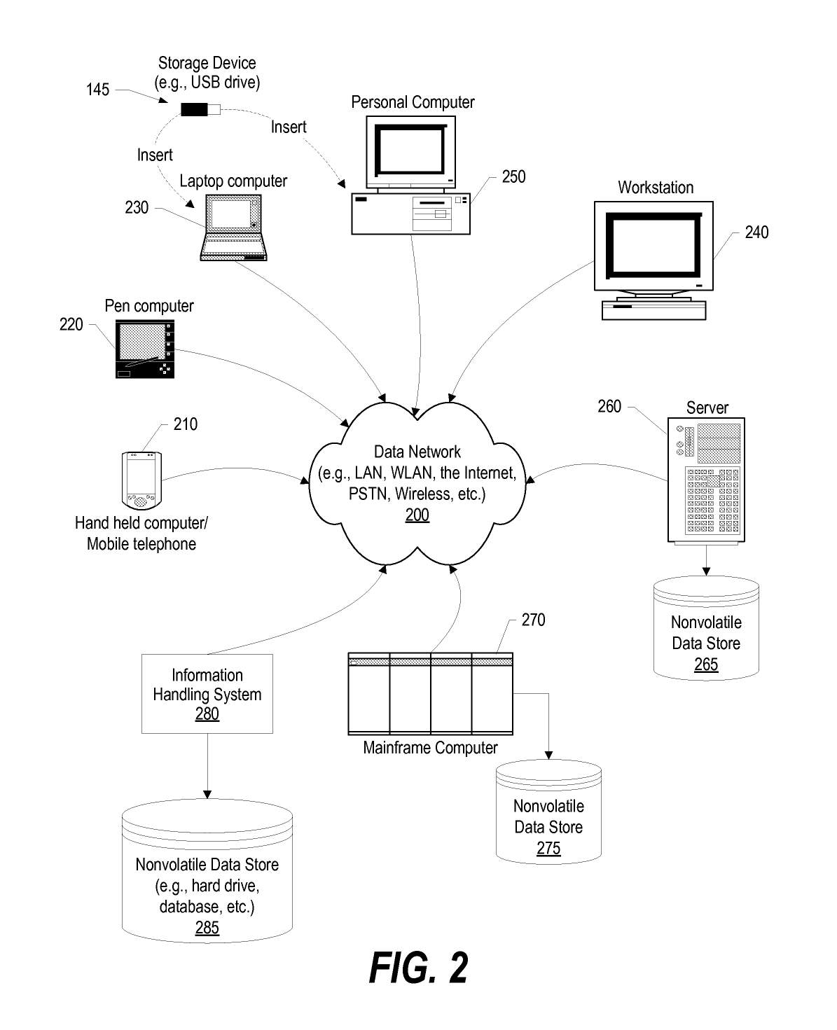

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

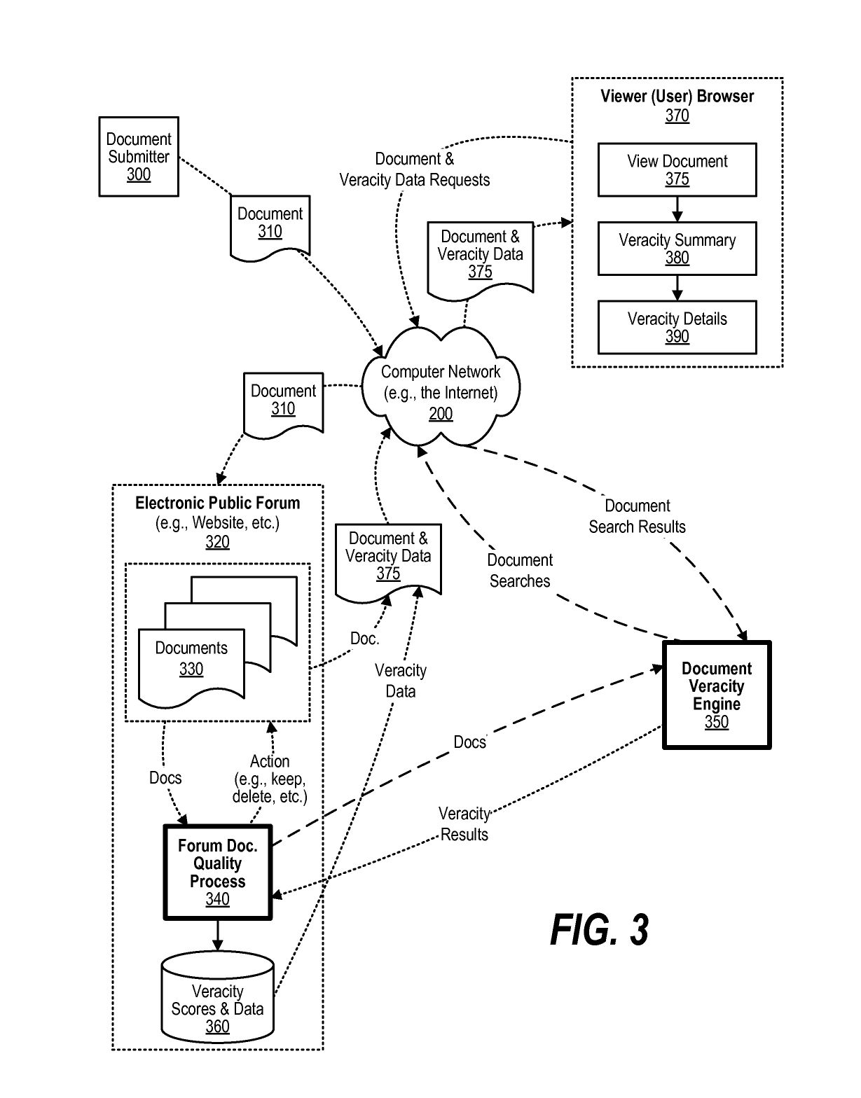

FIGS. 3-5 depict an approach that can be executed on an information handling system, such as a mobile device, and computer network as shown in FIGS. 1-2. A system and method to determine the veracity of an online post is shown and described. In this approach, a posting itself and information about the people who have acted upon the post in one form or another is automatically analyzed to derive a veracity score or to provide more detailed information to a user about the makeup and opinions of the community that has commented on the posting. This approach automatically determines the veracity of a document or posting by, first, automatically determining the topic of the posting. This can be achieved by matching documents against documents known to belong to a certain category or by matching documents against (weighted) dictionaries derived from documents known to belong to a given category. Second, the approach Identifies people (action originators) who have acted on the posting (by, for example “liking”, “disliking”, resharing, or reposting the posting, providing a comment, or leaving some other traceable information).

Third, the approach identifies the number of action originators that completed an action in response to the posting (for example “liked”, reshared or reposted the posting, or adding a comment or left some other traceable information. Fourth, the approach collects information about the action originators who acted upon the posting. Information can be collected from online sources such as social media profiles, publications, professional public profiles, etc. Fifth: the approach determines the action originators' expertise and/or credibility by inspecting public information such as social media profiles or public articles of the persons in the list and correlating this information with the topic of the document that was established in the first step. Sixth, the approach analyzes and summarizes the collected information. In one embodiment, a single veracity score is calculated from a ratio of weighted sums of the number of the action originators who performed positive actions (e.g., “liked”, etc.) or negative actions (e.g., “disliked”, etc.). In another embodiment, a summary of the skill categories of the action originators who have acted positively or negatively on the posting (e.g., 70% of doctors liked this posting, etc.). Another example is providing the user with a list of people who have commented positively or negatively on the posting along with their expertise (e.g. a list of all the doctors who commented on a post, etc.). In another embodiment, the user is presented with a list of all the people, their expertise, and their posted comments. Lastly, the approach provides feedback to the user based on the analysis of the profiles of people who have commented on the posting. In one embodiment, a user receives feedback by using a pointing device (e.g., mouse, etc.) and “hovers” over an icon such as the “Like” Icon to display a veracity score or can right-click on the icon to enter a user interface that allows exploration of the analyzed information. The approach discussed above is further described in FIGS. 3-5 and accompanying detailed descriptions, discussed below, which provide further details related to one or more embodiments that provide veracity data pertaining to documents posted to an online forum.

FIG. 3 is a component diagram showing the various components used in performing automatically determining the veracity of documents posted to an online forum. Document submitter 300 submits document 310 to electronic public forum 320, such as an Internet website. Document 310 is received as a posting to electronic public forum 320 where it is stored with other documents 330 that are available for viewing by users of the forum. The electronic public forum or document veracity engine 350 automatically identify a topic for the posting. For example, the topic may be a particular medical procedure or practice. Document veracity engine 350, which may be executing as part of the electronic public forum or may be a separate network entity (website) identifies actions and corresponding action originators regarding the posting. Actions can include activities such as a comment directed to the document, a “like” (favorable vote), a “dislike” (unfavorable vote), a re-sharing, a posting, or any other action that is allowed on the electronic public forum. Document veracity engine 350 collects veracity information about the action originators with action originators being users that performed the aforementioned actions.

The veracity information is network accessible public information that is retrieved from social media profiles, professional profiles, publications, online searches, public articles, and any other network accessible public information found that relates to the action originators. The document veracity engine correlates the public information found for the action originators with the topic of the posting (document) in order to assign a veracity weighting that pertains to the action originators. For example, if the topic is a particular medical procedure and the action originator is found to be an expert with regards to the medical procedure, then the veracity weighting would be heavily weighted. In contrast, an action originator that is not found to possess any medical knowledge or expertise would have a low veracity weighting. In one embodiment, the document veracity engine computes a single veracity score that is constructed by a ratio of the sums of the number of users that voted on the actions. For example, if the action is a comment by a particular action originator and many users voted that the “liked” the comment or that they found the comment useful, then the veracity score would be higher than a comment that had few if any votes affirming the comment.

In one embodiment, electronic public forum 320 executes forum document quality process 340 that utilizes veracity results from document veracity engine 350 in order to decide whether to retain the document in the electronic public forum or discard the document as being unreliable or untrustworthy. The forum document quality process can be executed periodically in order to wait for actions (comments, “likes”, etc.) to be generated for the document over time. Rather than discarding documents from the forum, in another embodiment documents with low veracity scores are made available to views of the electronic public forum but the viewer is warned of the low veracity score or is otherwise able to view the veracity information that indicates that the document has a low veracity score and is not credible based on the actions taken with regard to the document by the various action originators. The veracity scores and data used to compute the veracity scores (e.g., details regarding the actions taken, the data gathered about the action originators, etc.) is stored in data store 360.

A viewer, or user, of electronic public forum 320 is depicted by entity 370 that uses a veracity user interface provided by the electronic public forum to view veracity information pertaining to a posting on the electronic public forum, such as a document. In one embodiment, the veracity user interface is displayed on a Web browser that allows the user to view the veracity score pertaining to a document (veracity summary 380). When a document is selected by the viewer from electronic public forum 320, the electronic public forum transmits the requested document along with veracity data that pertains to the requested document (transmission 375). Document transmission 375 is received at the user's information handling system and displayed, such as in a browser that is running on the user's information handling system.

The user can also “drill down” and view actions taken with regard to the document as well as votes (e.g., “liked”, “found favorable”, etc.) that were placed on the various actions (veracity details 390). The votes placed on the actions are displayed to the viewer at browser session 370. The veracity user interface is also used to display, or otherwise provide, a weighted veracity summary to the viewer of the online posting. The weighted veracity summary is formed by analyzing the actions in light of a veracity weighting that is assigned to each of the action originators based on the collected veracity information. In one embodiment, a semantic analysis of the actions is performed by the document veracity engine to derive a ranking for a respective comment, with the ranking being on a scale from a positive ranking to a negative ranking.

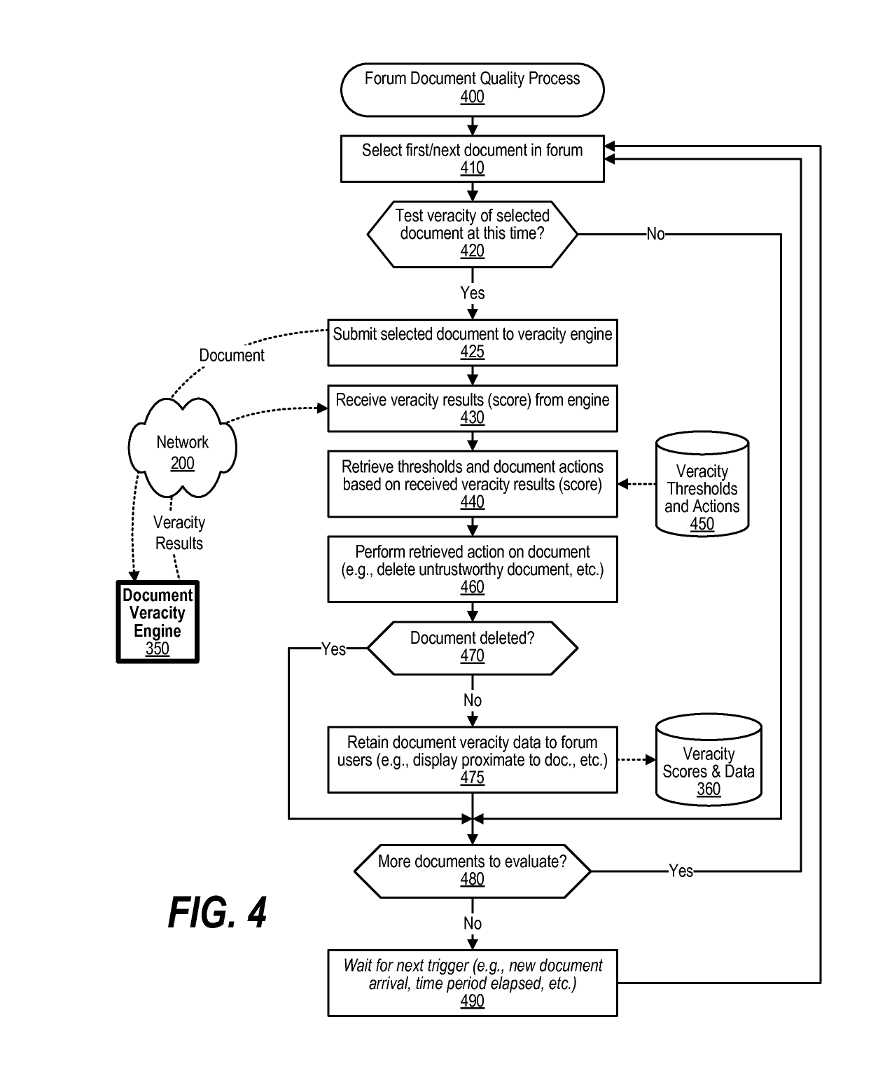

FIG. 4 is a depiction of a flowchart showing the logic used in a forum document quality control process that generates veracity data based on document actions. Processing commences at 400 whereupon, at step 410, the process selects the first online posting, such as a document, from the electronic public forum. A decision is made as to whether it is time to test the veracity of the selected online posting (decision 420). For example, some amount of time may be provided for action originators to initiate actions (comments, votes, “likes”, dislikes, re-sharing, posts, etc.) for the posting. Additionally, processing might wait until some number of actions are received for a particular posting before performing the quality control process. If it is not time to review the selected posting then processing branches to the “no” branch which bypasses steps 425 through 475 that perform the quality control process. However, if it is time to review the selected posting, then decision 420 branches to the “yes” branch to perform the quality control process on the selected posting.

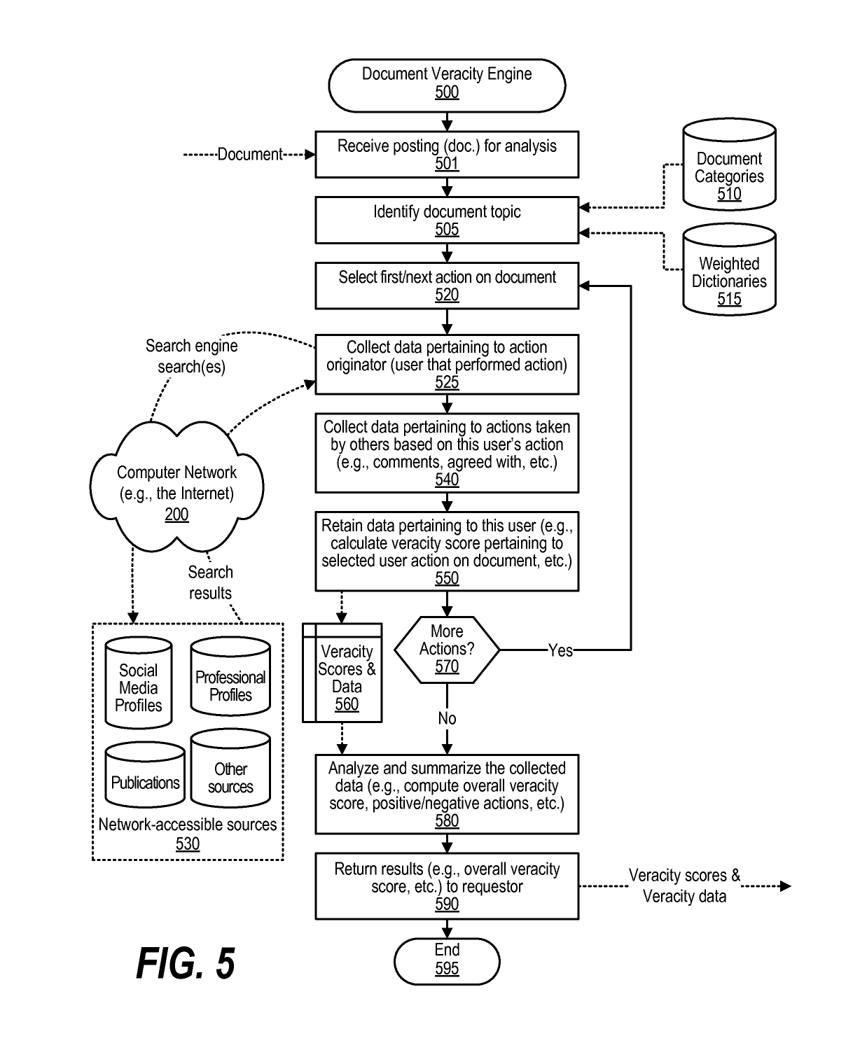

At step 425, the quality control process submits the selected posting to document veracity engine 350 via computer network 200, such as the Internet. Processing performed by the document veracity engine is shown in FIG. 5. At step 430, the quality control process receives veracity results and data from the document veracity engine. At step 440, the quality control process receives thresholds and quality control actions from data store 450. In one embodiment, the thresholds specify veracity score ranges and corresponding actions that are performed on the document based on the veracity scores. For example, postings that do not have a minimum threshold veracity score might be deleted from the electronic public forum by the quality control process. In addition, for those documents with high veracity scores, the quality control process might highlight the high veracity score documents as being most credible and trustworthy thus aiding the viewer in identifying postings with high veracity scores. At step 460, the quality control action retrieved at step 440 is performed on the posting (e.g., deleting the posting, highlighting the posting, retaining the posting, etc.).

A decision is made as to whether the quality control action resulted in the posting being deleted from the electronic public forum (decision 470). If the document was not deleted, then decision branches to the “no” branch whereupon, at step 475, the veracity data is retained in data store 360 so that the veracity data (e.g., veracity summaries, veracity scores, actions taken to the posting to generate the veracity score, action originators and such originators' gathered credibility data, etc.) can be made available to viewers of the posting. On the other hand, if the posting was deleted by the quality control process, then decision 470 branches to the “yes” branch bypassing step 475.

A decision is made as to whether there are more postings hosted by the electronic public forum that should be evaluated by the quality control process (decision 480). If there are more postings to evaluate, then decision 480 branches to the “yes” branch which loops back to select and process the next posting in the electronic public forum as described above. This looping continues until there are no more postings to be evaluated by the quality control process, at which point decision 480 branches to the “no” branch. At step 490, the quality control process waits for an event, or trigger, to occur before recommencing the entire quality control process. The event could be a new posting arriving at the electronic public forum, a period of time elapsing, etc. When the event occurs, the quality control process loops back to step 410 to recommence the entire process.

FIG. 5 is a depiction of a flowchart showing the logic used in a document veracity engine to gather document related veracity information used to generate veracity scores and other veracity data pertaining to online postings. Processing commences at 500 whereupon, at step 501, the veracity engine receives the posting, such as an online document, that is to be analyzed with the posting being sent from an electronic public forum, as shown in FIG. 4. Returning to FIG. 5, at step 505, the veracity engine identifies a topic associated with the received posting. In one embodiment, the veracity engine identifies the topic of the posting by matching the retrieved posting against documents (e.g., previous postings, etc.) known to belong to a certain category with such document retrieved from data store 510. Additionally, the veracity engine can identify the topic of the posting by matching the posting against (weighted) dictionaries derived from documents known to belong to a given category which are stored in data store 515. The comparison to words and phrases in the weighted dictionaries essentially compares keywords found in the received posting (e.g., title, abstract, etc.) with words and phrases retrieved from weighted dictionary data store 515 known to belong to certain topics. For example, if the title of the received posting included a medical term, such medical term might be found in another document or weighted dictionary indicating that the posting has a medical topic.

At step 520, the veracity engine selects the first action that was performed on the online posting (e.g., “liked”, reshared or reposted the posting, adding a comment or left some other traceable information). At step 525, the veracity engine collects data pertaining to the action originator with the action originator being the user that performed the selected action. As shown, step 525 searches network-accessible (online) sources 530 for data regarding the action originator. These network-accessible sources include the action originator's social media profiles, the action originator's professional profiles, the action originator's publications, and other online sources. The result of step 525 is a determination of the action originators' expertise and/or credibility by inspecting public information such as social media profiles or public articles of the persons in the list and correlating this information with the topic of the document. In addition, at step 540, actions pertaining to the selected action are collected and analyzed. For example, if the selected action was a favorable comment or other type of endorsement (e.g., “liked”, agreed with, etc.) of the posting, having other users that agreed with the endorsement would serve to increase the veracity score and provide additional supporting data for the veracity score. In addition, the expertise and/or credibility of the users that acted on the action can also be evaluated such as shown in step 525. For example, if a physician endorsed the online posting and such endorsement was further endorsed (e.g., “liked”, agreed with, etc.) by a well known highly-respected physician, such additional endorsement would serve to increase the veracity score applied to the posting. Moreover, a quantity of endorsements can also be used so that, for example, if a large number of users endorsed the action originator's action such large number of secondary-endorsers would further serve to increase the veracity score applied to the online posting.

At step 550, the veracity data pertaining to the action originator for the selected action is retained in memory area 560 (e.g., veracity summaries, veracity scores, actions taken to the posting to generate the veracity score, action originators and such originators' gathered credibility data, etc.). A decision is made as to whether other action originators placed additional actions on the online posting (decision 570). If additional actions are found, then decision 570 branches to the “yes” branch which loops back to select the next action and action originator and collect veracity data corresponding to the action originator as discussed above. This looping continues until there are no further actions to process, at which point decision 570 branches to the “no” branch.

At step 580, the veracity engine analyzes all of the veracity scores collected by analyzing all of the actions associated with the online posting in order to generate a weighted veracity summary which is computed based on the positive and negative actions associated with the post with such actions being weighted by the credibility and/or expertise found to be possessed by the action originators that generated the actions. At step 590, the veracity results (e.g., veracity summary, veracity scores, underlying veracity data, such as the action originators expertise and credibility data used to compute the veracity summary and scores, etc.) are transmitted to the veracity requestor, such as the electronic public forum shown in FIG. 4, with the transmission being made through computer network 200, such as the Internet. Veracity engine processing thereafter ends at 595.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method of determining the veracity of an online posting comprising:
identifying a posting on an electronic public forum;
automatically identifying a topic for the posting;
identifying one or more actions and corresponding action originators regarding the posting;
collecting veracity information pertaining to a set of one or more of the action originators;
assigning a veracity weighting for the set of action originators based on the collected veracity information;
analyzing the actions with the veracity weighting to form a weighted veracity summary; and
providing the weighted veracity summary to a viewer of the online posting.

2. The method of claim 1 wherein the collecting veracity information about the set of action originators further comprises:
retrieving network accessible public information selected from the group consisting of social media profiles, professional profiles, publications, online searches, and public articles.

3. The method of claim 2 further comprising:
correlating the public information with the topic of the posting to assign the veracity weighting for the set of action originators.

4. The method of claim 3 wherein the weighted veracity summary is a single veracity score constructed by a ratio of weighted sums of a number of users that placed votes on the actions.

5. The method of claim 4 further comprising:
providing a veracity user interface to the viewer, wherein the veracity user interface corresponds to the posting;
receiving a veracity selection at the veracity user interface;
retrieving the votes placed on the actions;
displaying the votes placed on the actions to the viewer.

6. The method of claim 1 wherein the actions are selected from the group consisting of a comment, a like, a dislike, a re-sharing, and a reposting.

7. The method of claim 1 wherein a semantic analysis of the actions is performed to derive a ranking for a respective comment, wherein the ranking is on a scale from a positive ranking to a negative ranking.

8. An information handling system comprising:
one or more processors;
a memory coupled to at least one of the processors;
a set of instructions stored in the memory and executed by at least one of the processors to determine a veracity of an online posting, wherein the set of instructions perform steps of:
identifying a posting on an electronic public forum;
automatically identifying a topic for the posting;
identifying one or more actions and corresponding action originators regarding the posting;
collecting veracity information pertaining to a set of one or more of the action originators;
assigning a veracity weighting for the set of action originators based on the collected veracity information;
analyzing the actions with the veracity weighting to form a weighted veracity summary; and
providing the weighted veracity summary to a viewer of the online posting.

9. The information handling system of claim 8 wherein the collecting veracity information about the action originators further comprises:
retrieving network accessible public information selected from the group consisting of social media profiles, professional profiles, publications, online searches, and public articles.

10. The information handling system of claim 9 wherein the steps performed further comprise:
correlating the public information with the topic of the posting to assign the veracity weighting for the set of action originators.

11. The information handling system of claim 10 wherein the weighted veracity summary is a single veracity score constructed by a ratio of weighted sums of a number of users that placed votes on the actions.

12. The information handling system of claim 11 wherein the steps performed further comprise:
providing a veracity user interface to the viewer, wherein the veracity user interface corresponds to the posting;
receiving a veracity selection at the veracity user interface;
retrieving the votes placed on the actions;
displaying the votes placed on the actions to the viewer.

13. The information handling system of claim 8 wherein the actions are selected from the group consisting of a comment, a like, a dislike, a re-sharing, and a reposting.

14. The information handling system of claim 8 wherein a semantic analysis of the actions is performed to derive a ranking for a respective comment, wherein the ranking is on a scale from a positive ranking to a negative ranking.

15. A computer program product stored in a computer readable medium, comprising computer instructions that, when executed by an information handling system, causes the information handling system to perform steps comprising:
identifying a posting on an electronic public forum;
automatically identifying a topic for the posting;
identifying one or more actions and corresponding action originators regarding the posting;
collecting veracity information pertaining to a set of one or more of the action originators;
assigning a veracity weighting for the set of action originators based on the collected veracity information;
analyzing the actions with the veracity weighting to form a weighted veracity summary; and
providing the weighted veracity summary to a viewer of the online posting.

16. The computer program product of claim 15 wherein the collecting veracity information about the set of action originators further comprises:
retrieving network accessible public information selected from the group consisting of social media profiles, professional profiles, publications, online searches, and public articles.

17. The computer program product of claim 16 further comprising:
correlating the public information with the topic of the posting to assign the veracity weighting for the set of action originators.

18. The computer program product of claim 17 wherein the weighted veracity summary is a single veracity score constructed by a ratio of weighted sums of a number of users that placed votes on the actions.

19. The computer program product of claim 18 further comprising:
providing a veracity user interface to the viewer, wherein the veracity user interface corresponds to the posting;
receiving a veracity selection at the veracity user interface;
retrieving the votes placed on the actions;
displaying the votes placed on the actions to the viewer.

20. The computer program product of claim 15 wherein the actions are selected from the group consisting of a comment, a like, a dislike, a re-sharing, and a reposting.
